(19) United States
(12) Patent Application Publication
(10) Pub. No.: US 2014/0222705 A1
(43) Pub. Date: Aug. 7, 2014

(54) RECOMMENDING STUDENTS TO PROSPECTIVE EMPLOYERS BASED ON STUDENTS' ONLINE CONTENT

(71) Applicant: COURSEPEER INC., Mississauga (CA)

(72) Inventors: Hadi Aladdin, Etobicoke (CA); Marwan Aladdin, Etobicoke (CA)

(21) Appl. No.: 14/087,725

(22) Filed: Nov. 22, 2013

Related U.S. Application Data
(63) Continuation of application No. PCT/CA2012/000489, filed on May 23, 2012.
(60) Provisional application No. 61/488,807, filed on May 23, 2011.

(51) Int. Cl. G06Q 10/10

(52) U.S. Cl. CPC G06Q 10/1053
USPC 705/321

(57) ABSTRACT

A system and method for recommending a producer to a consumer. An example is provided illustrating a social network for online learning. Students, teachers and employers contribute content to the social network. A recommendation engine obtains the content, extracts objects from the content and determines relationships among the objects and users. The relationships are used for generating a relationship graph. In association with activities and interactions provided by the students, conclusions are made about the students based on psychological and sociological analysis to match students to employers and opportunities.

### CROSS REFERENCE

This application claims priority from U.S. patent application Ser. No. 61/488,807 filed May 23, 2011, incorporated herein by reference.

### TECHNICAL FIELD

The following relates generally to recommending a producer to a consumer.

### BACKGROUND

Group discussions and other collaborative environments are common among students. Within such discussions, certain students may ask many questions and others may provide many answers. Some may indicate more interest in the topics and others may indicate less. Some may be more engaged and others less so.

As is well known, at the conclusion of most courses, students are awarded grades reflecting their knowledge of the subject matter covered in the course. Typically, teachers determine such knowledge level from a combination of exams, academic papers and assignments. However, some students are better at succeeding in exams, academic papers and/or assignments relative to their actual knowledge measured among all the students in the course. Therefore, as is also well known, grades are not necessarily a conclusive indicator of such knowledge.

Grades are a primary indicator that are used by potential employers when evaluating students for job opportunities, as they are one of the primary quantitative metrics available to the employers. Additionally, employers commonly base their recruiting decisions on data from resumes, reference letters or live interviews.

Current human resources and talent management processes utilize some automation tools. Filters are used to remove unqualified candidates, but then require significant effort to review resumes that pass these filters. Additionally, these filters drop many suitable candidates for not matching resume standards. Keyword searches are also available to locate best-match candidates. Next, the typical interview process tries to capture soft skills and capabilities of possible candidates, which cannot be easily gleaned from resumes or reference letters. This raises the expense of recruitment and delays the recruitment process.

It is an object of the present invention to mitigate or obviate at least one of the above disadvantages.

### SUMMARY OF THE INVENTION

In one aspect, a method for recommending at least one student to an employer over a computer network, comprising: (a) obtaining, by one or more computer terminals, content from the at least one student and the employer; (b) extracting at least one object from the content; (c) generating a relationship graph linking the at least one objects and at least one student and the employer; and (d) recommending, by a recommendation engine, at least one student to the employer based on the relationship graph.

In another aspect, a recommendation engine for recommending at least one student to an employer over a computer network, comprising: (a) a content unit operable to obtain content from the at least one student and the employer and extract at least one object from the content; and (b) a monitor/analyzer unit operable to generate a relationship graph linking the at least one objects and at least one student and the employer and recommend at least one student to the employer based on the relationship graph.

### BRIEF DESCRIPTION OF THE DRAWINGS

Embodiments will now be described by way of example only with reference to the appended drawings wherein:

FIG. 1 is a system embodying the present invention in one aspect.

FIG. 2 is a recommendation engine.

FIG. 3 is an exemplary method in accordance with the present invention.

FIG. 4 is the operation of the content unit in one example.

FIG. 5 is the operation of the monitor/analyzer unit in one example.

### DETAILED DESCRIPTION OF THE DRAWINGS

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

In one aspect, the present invention comprises a social network for online learning. In another aspect, the present invention comprises a recommendation engine. In another aspect, the present invention comprises a social network enabling employers to review prospective employees.

The present invention provides a system and method for recommending a producer to a consumer. Producers provide data related to or indicative of particular attributes of the producer. A moderator may provide feedback regarding the producer or its data. Consumers may contribute data that is indicative of requirements for a particular item of interest. A recommendation engine recommends to the consumer one or more of the producers based on the foregoing.

The system generates relationships among users and content of a social network to provide data that can be leveraged to provide conclusions about the users. The system can further provide recommendations to consumers based on a set of requirements set out by the consumers. Content contributed by the producers, consumer and moderators is analyzed and organized into a relationship graph to determine the relationship among the content and the users, which enables the recommendations. Interactions and activities related to the objects may be used to generate the conclusions.

The relationship graph links all objects and users in the network, and for that reason all producers, consumers and moderators may be considered both producers and consumers. The definition of producer and consumer may adapt to the particular requirement at any given time, i.e., whether content is being obtained from a user (in which case they are a producer) or being provided to the user (in which case they are a consumer).

In one embodiment, the system and method enables a student or plurality of students to be recommended to an employer to fill a job posting. In such case, students are producers, employers are consumers, and teachers are moderators. Concurrently, students are provided with a platform for collaborating and more effectively learning, in which case students are both producers and consumers. Teachers are provided increased insight into the knowledge of the students for better evaluation of the students, in which case students are producers and teachers are consumers. Teachers may provide feedback to the students, in which case teachers are producers and students are consumers.

The present invention provides an intelligent measure of student behaviors and activities, which may be analyzed using sociological and psychological profiling algorithms to provide conclusions. The sociological and psychological profiling algorithms may be configured to suit the particular application of the invention, for example as a social network for online learning.

Further, the present invention enables matching between students and job opportunities associated with employers. The matching may be restricted to those cases for which the student has provided consent (such as, consent to use their profiled information). Thus, employers may post job opportunities and be provided with suggestions of suitable candidates from among the students. Employment recommendations, for example, may be made intelligently based on the foregoing relationships and conclusions as well as the employer's requirements and feedback from teachers. Employer requirements could be obtained, for example, from a job posting created by the employer or could be generated by content associated with the employer.

Additionally, the present invention provides a data set from activities of students, teachers and employers which can be translated to provide a set of relations and interests which can be analyzed by machine learning algorithms to adjust the learning experience of the student, such as connecting them with like-minded people, alerting them to related research papers, associating them with patents and other content, and so on.

The present invention may further provide analytics from static and dynamic variables which may be represented graphically to aid a teacher in improving the course experience. Teachers may also embody their own algorithms, and/or crowdsource the creation of algorithms among a community of teachers, to be applied to data relating to the course, enabling others to adopt new methodologies of successful teaching. These algorithms could use the variables made available by the invention, and can be expressed in a Structured Query Language (SQL).

The present invention may be suitable for universities, colleges, schools, corporate learning environments, government ministries and departments or any other system in which one party seeks to evaluate the effectiveness or suitability of particular persons, entities or products for particular tasks, roles or fulfilment.

The foregoing embodiment directed to a social network for online learning will be used illustratively throughout the present description, however there are numerous other examples of producers, consumer and moderators for which the present application may apply. Some such examples include: 1) consultancy agencies (consumers), consultant (producer), and employers (moderators) where consultants use the network to contribute material within their knowledge to reflect their strengths; 2) employers (consumers), project manager (producer), and project manager's clients (moderators) where project managers use the network to manage the moderators' projects as well as contribute to the knowledge of other project managers in a social manner, which may attract other employers who are interested in their services; 3) language agencies (consumers), language translator or interpreter (producer), and clients (moderators) where language translators or interpreters provide their language services on an online or offline platform, and contribute to the knowledge base of other translators, as well as document their experiences and discuss them with other professionals; 4) company X that produces a product or a machine (consumer), user of the product or machine with enough knowledge to address questions or support tickets/requests of other users (producer), and clients requesting support or help for a specific product of company X (moderators) where the knowledgeable users help the clients, are awarded specific titles or badges based on the feedback of the person being helped, or which will enable company X to offer them a full-time/part-time opportunity to work in company X; 5) companies in need of crowdsourcing their online marketing (including affiliate and referral marketing) or social media needs (consumers), user of the internet and social networks to promote services or products of companies (producer), and users of the internet or social networks that are being approached by the producers to convince them to buy a product or a service (moderators) where the companies that need to initiate new marketing plans and would like to rely on active, engaged and convincing online marketers can use the platform to find such candidates.

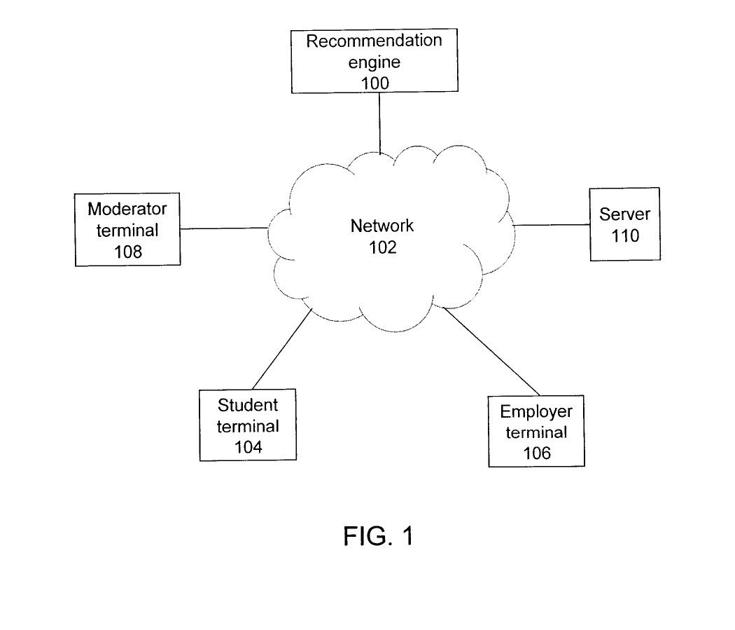

Referring now to FIG. 1, a system embodying the present invention in one aspect is shown. The system comprises a recommendation engine 100 that operates upon content accessible via a network 102. The network 102 links one or more student terminals 104, employer terminals 106 and moderator terminals 108 which each enable access to the network by students, employers and moderators, respectively. The students, employers and moderators may collectively be referred to as “users”.

Preferably, the network is a social network administered by one or more servers 110 operating in the cloud. The social network preferably supports activity streams, as that term is known in the art. Preferably, the network is a social network which supports posting and hosting of content, commenting on content and activity stream items, “liking” content and activity stream items, making connections among users, user profile pages (or user web pages), etc. Any of the following content may be disseminated via an activity stream, and may be limited by privacy settings, as described herein.

Users contribute data comprising content, activities and interactions to the network via the terminals. Moderators may, for example, be teachers that contribute course content and feedback in respect of students. Students may contribute questions, answers, discussion, ratings and other content. Employers may contribute job postings and setting out prospective candidate requirements and other content from which information about the employer can be derived.

In one example, a plurality of students and teachers are each associated with accounts in a social network. A teacher may create a course page on the social network for a course and add a corresponding syllabus, which comprises a set of topics, accessible on the course page. The teacher may assign for each such topic one or more keywords or hashtags which may, in a social network, be recognizable by a symbol, such as a number sign or hash symbol (e.g., “#hashtag”) for example. The keywords may be selected from among a set of predefined keywords, or the teacher may define new keywords.

Teachers may further contribute content to the course page. Content may comprise lecture material including digital notes, recordings (audio or video), and black board still image captures. Content may further comprise third party content related to the course content but not formally part thereof, for example third party news articles or research papers of relevance to the course.

Students that are enrolled in the course may create a connection to the course by indicating a connection to the course page, such as by “liking” the page, subscribing to updates from the page, or simply using the keyword associated with topics for the course or any of its content. The students' activities may be reflected on their respective activity stream so that it may be visible to other users.

Students use the social network, in part, to engage in learning opportunities with other students and the teacher. These engagements take the form of “activities” which take place by the use of “interactions”. For example, students may ask questions (an activity) by typing out a question including the relevant keyword(s) and posting the question (wherein the act of posting is the interaction) to their activity stream. As will be appreciated, students are incentivized to engage the social network since it is likely that increased engagement will be correlated to increased learning, which further correlates to higher grades and greater job opportunities. Students may use the social network to study, contribute, help others, get help, receive job offers, receive teacher recommendations and suggest course improvements.

Teachers may provide feedback to students. For example, teachers may “like” content provided by students (such as answers to questions), and can provide badges (e.g., merit badges, attendance badges, and other awards), a rating, reference letters, recommendations, text based positive or negative review, etc.

The foregoing data provided by the users constitutes content. The keywords indicate what the content refers to, and the remaining information may be classified as “objects”. In other words, “objects” are connected to “keywords”.

Employers may additionally contribute content to the social network. For example, an employer may create a job profile for a job opportunity. The job profile may comprise a set of keyword and objects. The objects may include demographic information related to the job, including location, age, field of interest, etc. An employer may post a job posting including static and dynamic parameters. Dynamic parameters may, for example, include habits, interests, or any attributes of a candidate that might change over time, while static parameters may include grades.

As will be described further herein, the recommendation engine generates recommendations of students that are likely to be suitable for such job opportunities based on the keywords and objects associated with the job profile and those associated with interactions and activities of the students and teachers. Students may be analyzed based on a plurality of metrics, including interest and knowledge in particular subjects, physical location and grades, and feedback from the moderator (teacher).

Teachers may also derive benefits from the present invention, including, for example, to enhance and improve courses. For example, the recommendation engine 100 may comprise one or more analysis module 110 operable to apply an analysis to content contributed by users. Analysis modules may be developed by teachers, experts or crowdsourcing.

Each user may be associated with a user profile. Any or all of the user profile may be hidden behind a privacy wall, which may comprise network defined and/or user defined privacy settings. Example privacy settings may be global or individual to particular profile elements, and may include: private (available to the specific user only), friends/coursemates only, professionals or mediators only, employers only, custom (a combination of specific or all/some of the foregoing), or public (everyone).

In particular, students may be associated with student profiles comprising a set of features, elements, ideas, activities, tags and keywords. The profile may comprise home country, resident country, education (school, campus, major, date of graduation and board tests), experience (employment, specialities, military, development events, awards, recommendation letters, CV/resume), skills (personal leadership, languages spoken, computer, IQ tests results, professional exams, certifications or licenses, leadership information and recommendation letters), interests (arts, athletics, community involvement, clubs, student government, groups, activities, sports, hobbies, affiliations and awards or honours), career preferences (job type, salary, location, industries and employers), courses (titles, marks and projects or achievements), bookmark rating, questions and answers rating, market requests and offers rating, life experiences rating and collaboration rating, and any other profile or demographic information that may be directly or indirectly related to learning, employment or social networking.

Employers may be associated with employer profiles, including location, field of business, size, revenue, employment opportunities, growth expectations, etc.

As previously mentioned, the recommendation engine generates a relationship graph among all objects and users in the network. The recommendation engine may further recommend connections between users and other users, or users and objects, based on the relationship graph in conjunction with user-defined or predetermined thresholds.

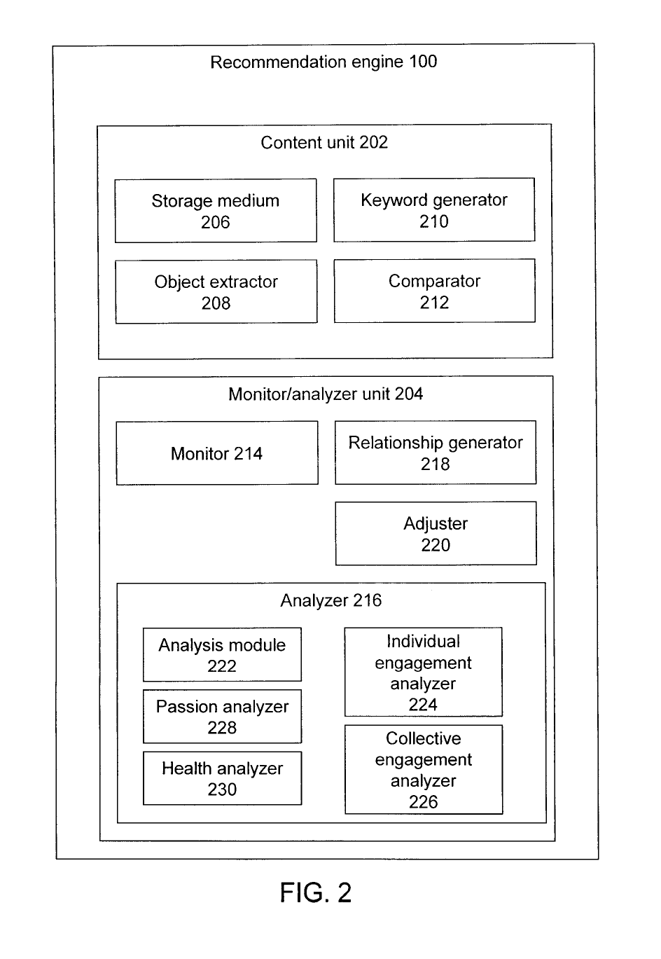

Referring now to FIG. 2, the recommendation engine 100 comprises or is linked to a content unit 202 and monitor/analyzer unit 204. The content unit 202 may comprise a plurality of modules comprising a storage medium 206, object extractor 208 and keyword generator 210 and a comparator 212. The monitor/analyzer 204 unit may comprise a plurality of modules comprising a monitor 214, analyzer 216, relationship generator 218 and adjuster 220. The analyzer 216 may apply one or more analysis modules 222, comprising, for example, an individual engagement analyzer 224, a collective engagement analyzer 226, a passion analyzer 228 and a health analyzer 230.

The storage medium stores content including text, image, video or audio, such as but not limited to posts, comments, likes, tags, ratings, questions, answers, articles, research papers, images and video frames, which may comprise text or recognizable objects, and icons.

The object extractor obtains and parses content to extract objects from the content. Objects may be identified by keywords and may comprise posts, comments, likes, questions, answers, articles, research papers, images, video frames and icons.

In particular examples, objects may comprise links to additional content (internal or external, online or offline) which may be obtained by the object extractor and then parsed to extract objects. The object extractor may also mark the degree/level of how far the object is from its parent. Content obtained by the object extractor may be stored on the storage medium.

An example of such linking comprises a student answering a question posed by another student. In this example, the answer links to the question and, therefore, the question may be considered the parent of the answer. In another example, a second question references the answer to the first question, so that the answer to the first question is the parent of the second question.

The keyword generator obtains content to generate keywords related to the content. The keyword generator may apply a keyword generating algorithm such as KEA or Lingo3G, for example.

Once all objects have been extracted, the comparator compares every object and/or user (including students, teachers and employers) to each other, typically two at a time, to determine relationships between objects and/or users. Comparison may further comprise dimensions including size, time of occurrence, weight and distance (levels). For example, the comparator may compare: user A liked question 1, user A provided five comments on question 1, answer 1 was linked to question 1, answer 2 was linked to answer 1, etc.

The relationship generator generates a relationship graph to represent the relationships among objects and users. The relationships may be assigned a weight (for example, based on how far or connected these objects or users are. In the relationship graph, users may be represented as vertices with edges extending and connecting to objects. The weighting in the relationship graph may be obtained from a weighted graph algorithm to represent the relationships among all of the objects and users in all of the content in the network.

The adjuster is used to cascade any changes to the relationship graph based on newly provided and analyzed content. Since any new content may have any number of links to objects in the current relationship graph, they may affect the relationship graph. The adjuster effects such modifications. The adjustor applies weighted graph algorithms to adjust weighted graphs to relate objects and users.

The monitor monitors the network for interactions and activities of objects and/or users, and the analyzer generates opportunities for recommending objects or users to other users. The interactions may, for example, include clicks, highlights, hold, duration of hold, hovers (including their screen-view coordinates), scrolls and dimensions (e.g., time, place, location, frequency of occurrence, or any other dimensions). The activities may, for example, include like, dislike, rate up, rate down, rate share, comment, download, upload, create a new object (e.g., ask a question, bookmark, answer a question), change an object's status (delete, hide, make anonymous, change permission), responsiveness, effectiveness and badges.

The monitor may apply a date/time stamp to each of the interactions and activities. The analyzer further analyzes the captured interactions and activities and generates conclusions for those opportunities. The analyzer may further be used to generate conclusions about the users of the social network by applying one or more labels to a particular user, such as innovator, researcher, problem solver, leader, collaborator or curious, for example. A conclusion may comprise detailed information about the user, including, for example, activity and interaction statistics as well as general psychological and sociological measures based on activities performed by the user.

Conclusions can be used by the recommendation engine to push content or opportunities of interest to the user. For example, the analyzer may conclude that “User B has high interest in #hashtag” resulting in the recommendation engine pushing at a particular frequency (e.g., once per day) to the user's activity stream those objects that are linked to the hashtag within a particular number of levels in the relationship graph. Conversely, a conclusion of “User A has low interest in ‘#hashtag’” may result in pushing the objects to user A at a lower frequency (e.g., once per week) or not at all. Reactions to the objects pushed to the activity stream are objects that may be fed back into the recommendation engine to refine the conclusions.

The analyzer may generate conclusions about users among a set of pre-set reasons that the user took a certain action and with use of the relationship graph.

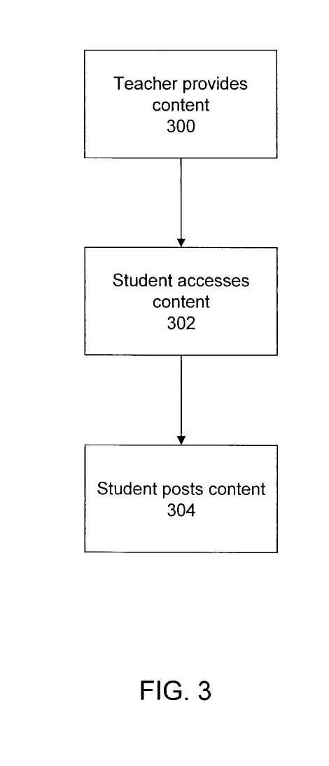

Referring now to FIG. 3, an exemplary method in accordance with the present invention is shown. A teacher has provided content 300, for example by providing course content on the social network. The course content is associated with keywords defined by the teacher.

A student accesses the course content 302. A student's course management page may enable a student enrolled in the course to create a connection to the course, such as by “liking” the course page, subscribing to updates from the course page, or simply using the keyword associated with topics for the course or any of its content. The student may alternatively access her course management page to add a course (or delete a course). The course may then be shown on the student's course management page as a course to which they have connected.

The student may enable or disable, for each course, the content that will be disseminated via the user's activity stream, which content may comprise, for example, relevant patents, industry or corporate updates and news (whether it is posted or announced on universities websites or over the web from trusted sources), relevant research information and updates, relevant career opportunities and tips, relevant social bookmarks, relevant market requests, relevant life experiences and places and relevant government announcements. The content may also be filtered by what type of activity it is in relation to, e.g., answers, questions, etc. The student may also set whether to receive activity stream updates when other students undertake activities in respect of the course.

The student may post a link to content on the student's activity stream 304, using the keyword or a plurality of keywords (e.g., “#keyword1 #keyword2 content”).

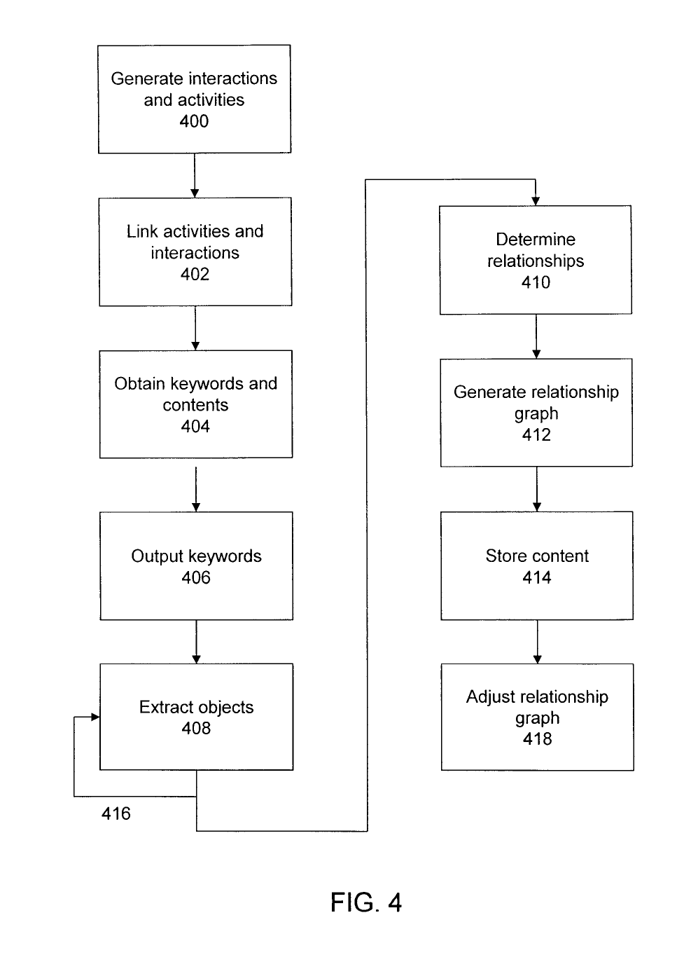

Referring now to FIG. 4, the operation of the content unit in one example is described. During the accessing and during the posting, a plurality of activities and interactions take place 400. For example, the act of the student activating a command to initiate a post is an interaction. The act of actually providing the link to content is an activity. The act of initiating a command to post the link is another interaction. Each of these activities and interactions are linked to the selected keyword(s) and the object being created 402, as well as the user doing them.

The keywords and content are obtained 404 by the keyword generator which outputs 404 the keywords. The object extractor obtains the content to determine whether objects must be extracted therefrom and extracts them 406, which are then associated with the created object (the content) and the keywords. The comparator determines relationships 410 between each object, user and keyword, and the relationship generator generates a relationship graph 412 which marks relationships among objects to generate a hierarchy of objects (an object network of parent/child relationships). The content is stored on the storage medium 414. The content may itself contain links to further content, which may have been similarly obtained and stored. The process of obtaining objects may occur iteratively 416 for a predetermined or preconfigured depth (number of times to obtain further linked content).

Provided that a relationship graph is already in existence, it may be necessary to adjust the existing relationship graph given the newly obtained content. The adjustor may be used to reflect any cascaded changes by combining the newly obtained content relationships with the existing relationship graph to generate an updated relationship graph 418.

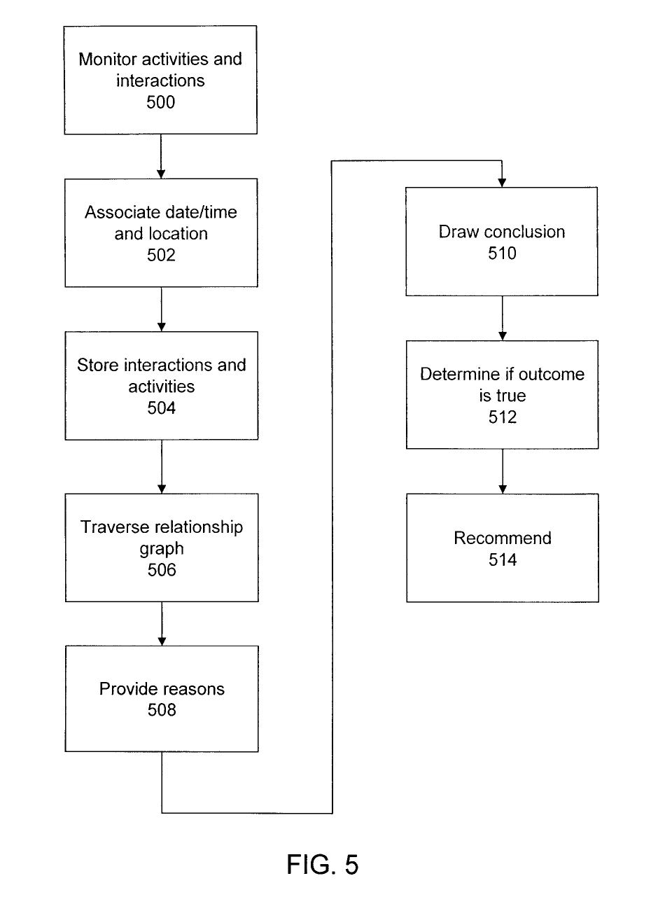

Referring now to FIG. 5, the operation of the monitor/analyzer unit in one example is now described. The monitor/analyzer unit operates periodically or on demand. The monitor monitors the activities and interactions on the network 500, as well as new objects or users. The monitor associates a date/time stamp and location stamp to all interactions and activities 502. The location stamp may comprise Object ID (e.g., the activity or interaction was performed on a question, or a certain image, or a certain attached file, etc.) and screen coordinates. The monitor stores the interactions and activities in a FIFO (First-In-First-Out) queue on the storage medium 504.

The analyzer applies one or more analysis modules to determine where the user stands on the knowledge graph, provides reasons for the user's interactions and activities, and draws conclusions. First, the analyzer traverses the relationship graph 506 to determine how far the user's attributes are from the object's attributes (the one the user is acting on), as well as comparing such attributes against the parent of that object, and the owner of that parent object. The further level through the graph the less effect it has on the relation.

The analyzer provides a set of scores/statistics and pre-set reasons 508 based on the distances and attributes. Then, the reasons are aggregated to draw conclusions 510, which may be based on pre-set conclusions that are provided by the analysis module. Analysis modules may be developed based on psychological or sociological profiles. The conclusions further assist the relationship generator to improve the connectivity of objects on the graph.

Pre-set reasons are dependent upon the application of the system. For example, in the context of learning, pre-set reasons for answering a question may comprise: (i) demonstrate knowledge; (ii) address concern; or (iii) extend concern. The particular pre-set reasons for any of the interactions and activities may be developed based on psychological or sociological reasoning.

The most likely reason, which becomes the conclusion, may be selected by reviewing the user's interactions and activities surrounding the object, the most likely reason may be selected. For example, the analyzer may review the activities and interactions to determine whether they are consistent with a reason (thereby making the reason more likely) or contradict a reason (thereby making the reason less likely). For example, if pre-set reasons for a user answering question A comprise demonstrate knowledge, address concern and extend concern, and later the user asks another question B on the same topic as question A, then a less likely conclusion may be demonstrates knowledge. The analyzer obtains and analyzes the interactions and activities to realize specific sets of sociological and psychological outcomes and conclusions about the users. The analyzer reads the monitored data and summarizes the activities and interactions by attributes comprising actor, acting type, reason of action, and acted on. Actors have various attributes comprising interest, rating, responsiveness, influence (e.g., professor badges, seriousness within a course, etc.). The acting type is selected from interaction and activity. The reason of action is either implicit or explicit (direct or indirect) and is determined based on how the user took the action. The acted on attribute is selected from user or object.

The analyzer connects to the comparator, which may apply heuristics to estimate whether a particular outcome is true (likely) as against a set of predetermined or configured thresholds (error tolerances). The comparator may apply a set of statistical algorithms to determine whether the outcome is true 512.

For example, the comparator may be used to determine whether a user has an interest in a specific topic. In one example, Mike is a student who posts questions about geography. His comments and likes, as well as interactions are tracked and measured. The comparator may determine whether Mike is near (has a liking of) “The Geography of the United States” by comparing: Mike likes USA, Mike posts about Geography, Mike comments on Geography tags, and so on. If these interactions meet or exceed the particular threshold, the analyzer may determine that Mike is interested in that topic, which will then be stored in the storage medium for later use. An example later use is an employer searching for someone with interest in geography North America, where Geography is among Mike's measured interests, and USA is located within North America.

The analysis modules considers the psychological or behavioural reasoning behind the user's interactions and activities. The analyzer analyzes the order of interactions and activities by referring to the FIFO queue. For this reason, the analyzer may provide different conclusions for two users engaging in identical activities through the application of different interactions. For example, a user contributing very quickly an answer to a question may be considered confident and knowledgeable in the related subject matter, whereas another user contributing more slowly the same answer may be considered apprehensive and unsure of the answer, despite the answers being identical. Additionally, the path a user takes from the moment they engage the social network to the point they see the question may be indicative of particular psychological or behavioural reasoning. Processes for conducting psychological or behavioural reasoning can be tailored by the administrator of the system, an expert in the field or crowdsourced.

Given the relationship graph, the recommendation engine may recommend objects to particular users based on the users' interests related to these objects 514. The recommendation engine reviews the relationship graph to determine, for example, to which course the object in question belongs. All objects that are one level below a course are marked with high priority (highly recommended). Priority is reduced for each subsequent level of objects from the course. Additionally, all recommended objects may be filtered by recency (based on the corresponding date/time stamp) so they can be displayed in ascending or descending order in the user's activity stream.

The recommendation engine may recommend one or more students to an employer. The employer may be provided a job description and/or candidate search query parameters. Such parameters may be dynamic or static. Dynamic parameters may include habits, interests, or any attributes that might change over time, while static parameters may include grades. When the job description is provided, it may be provided to the content unit. Once the content unit provides an output, standard aptitude tests and other human resources algorithms may be applied, and search query parameters may be fed to the monitor/analyzer unit along with the job description to determine a best match from the users of the network.

The recommendation engine may also recommend ways to reflect and improve a course. The reflection may be provided for teachers and students to measure where they (or the course) stand, while the improvement may enable teachers to enhance the educational experience with the same course members, or other course members among the network.

For example, one analysis module may be configured to provide a teacher with an answer to the question, “did over 70% of the students in my class understand this week's course topic?”. An example of the variables upon which the analysis module may operate to provide a response to this question may include: total number of students' likes of all answers under that specific course topic; the ratio of the total number of answers about that specific course topic to the total number of questions about that specific course topic; the ratio of the total number of students in the course that answered questions about that specific course topic to the total number of students that asked questions about that specific course topic; the total number of instructors' likes for answers per question in that specific course topic; the total number of students' likes; the total number of users viewing each answer about that course topic. The particular algorithms applied by the analysis module may be configured by the teacher, a developer, or crowdsourced.

In one example, reflection and improvement begins by obtaining interactions and activities from the storage unit. The interactions and activities may be processed by the analyzer to obtain an updated analysis of the course, its members and content (e.g., questions, answers, bookmarks, files, notes, tips, comments, etc.). This analysis may be provided to three analysis modules comprising individual engagement analyzer, collective engagement analyzer, and passion analyzer. Other analysis modules may be used to extend the analysis capacity.

The individual engagement analyzer analyzes the data and activities in the storage module to generate and measure various scores for the individual contribution on the network. The collective engagement analyzer measures, collectively, the contributions on the network (by users) and compares then accumulates them all to generate an overview over the course.

The passion analyzer may query the user to provide input describing their interest and passion about the topic(s) being measured or studied, and may use the datasets available to extract this information.

The health analyzer pushes tests and questions to users to measure how healthy the user or community is, around specific courses, topics or interests. The health analyzer further provides suggestions for improvement, based on a set of answers (order matters) that could be fed into it (previously) to measure over a period of time. For example, the course teacher creates the course topics in order to measure the effectiveness on students' understanding of the material in that order. If the outcome of the class shows that students did not comprehend the topics in that order, the teacher may request that the system alert him before the end of the first half of the semester such that he adjusts the course accordingly. This is analogous to a course review, yet it applies the psychological and sociological interactions and the relationship graph to accurately measure the health of the course. The result may benefit teachers on how to better target students, or good/bad practices or strategies used and rated by other teachers to provide a specific desired experience. Based on the user's answer results, a score will be determined and included to the total result. This score will determine the user health and community health for the topic or course.

The output of the individual engagement analyzer may provide course-oriented targeting for employers, which may also use the feedback loop of experience between mediators and their students. Additionally, the compactor may compare and embed the results of the output of analysis modules to provide reports (in terms of, for example, scores, stars, badges, or any other measures). This comparison may generate data for the health analyzer to generate conclusions regarding the health of the user or course community, which may affect the network health measure. The conclusions may be provided to teachers and students as suggestions for improvement, which then can be used or shared among the network of other students or mediators outside the course or the organizations, school or university. These suggestions may be generated based on pre-set parameters and questions that are answered intelligently by the analyzer.

In addition to the foregoing examples, numerous other forms of content may be contributed by users. One such example is bookmarks. Users may apply an academic social bookmarking tool to enable the users to bookmark articles, videos, audio, images or any other type of information, for themselves and other users, and useful material related to their courses, major, school, or any other categories that might be useful for the user. Users may further rate bookmarks, as well as leave comments. Social bookmarks may be disseminated by users' activity streams and may be commented upon, liked, rated, etc.

Another example of use of the social network of the present invention is an academic marketplace which may enable users to offer and request services for a kind of incentive in return. These incentives can then be reused to request other services, or possibly redeemed for special on-campus-offers. Users may rate market requests, report them for dispute, privately communicate, as well as use an escrow system or any model of compensation. A market request page may enable users to offer, request, accept, and fulfil services for some incentive. Incentives may be used to request other services or may be redeemed for offline purchases, such as on-campus redemption. Market offers, requests, acceptances and fulfilments may be commented upon, rated, disputed, etc.

Another example of use of the social network of the present invention is life activities. Users may post new life experiences and activities they experienced, best places they visited on campus or in the city of residence and announcements related to searching for roommates to rent a room on campus. A life experience page may comprise a mapping tool to reflect such experiences and activities. The recommendation engine may link these activities to any suitable category, including but not limited to clothing, entertainment, financial/banking/money matters, food/restaurants/meal preparation, fitness, groceries, housework, medication/hospitals, pets, recreation, religious/spiritual, rent/housing, safety procedures, shopping, study/libraries, and telephone/internet/communication. Users may rate life activities, as well as leave comments. The social network may further enable the user to assign a relevant map to be rendered on the page when the user or other users view the item.

Another example is annotation. Users may collaborate on editing or creating files of any format using a dynamic annotation tool, by pasting text, uploading a document/media file, and commenting or allowing others to comment on each word, paragraph, photo or each frame. Users may provide comments or feedback to annotations.

Additionally, the social network may enable users to browse and search job opportunities that have been provided by employers. The opportunities may be categorized into local and home country, or by job type. A list of mediators or professionals registered on the network may be listed beside job postings to notify a user of the availability for help to secure the job. Mediators can be testing centers or corporations in addition to teachers and organizations. Mediators may be provided incentives to provide such services. The suggestion of mediators may be made by employers, or may be made by the recommendation engine. In addition, the system may order the job postings based on matching of interests or by premium job posters (who may pay for advertising job postings), or any other suitable ways of ordering. Users may rate job opportunities as well as leave comments. Employers may provide a map to be rendered when a user views the item.

Similarly, employers may browse or search for job candidates among the students and teachers. For example, an employer searching for a candidate may either prepare a job posting (e.g., “I want an employee who has a grade of 80% and above in programming courses, passed technical tests (mention them), a team player, active in discussions of programming, likes to speak about telecommunications, and has a creative mind”) which is processed by the recommendation engine. Alternatively, advanced search using different filtering techniques may be provided. The system may render a map of location distribution of the possible candidates.

Additionally, government entities (e.g., ministries, departments or embassies) may disseminate announcements through students' activity streams. Such announcements may be disseminated to those students located in or citizens of particular governments.

Professionals and mediators may help students in preparing their CV, with interview assistance, or in getting better test results in aptitude tests or certain technical certifications (e.g. Microsoft development certifications).

Although the above has been described with reference to certain specific example embodiments, various modifications thereof will be apparent to those skilled in the art without departing from the scope of the claims appended hereto.

We claim:

1. A method for recommending at least one student to an employer over a computer network, comprising:
(a) obtaining, by one or more computer terminals, content from the at least one student and the employer;
(b) extracting at least one object from the content;
(c) generating a relationship graph linking the at least one objects and at least one student and the employer; and
(d) recommending, by a recommendation engine, at least one student to the employer based on the relationship graph.

2. The method of claim 1, further comprising associating a plurality of interactions and activities with the at least one object.

3. The method of claim 2, further comprising generating a conclusion regarding the at least one student corresponding to the at least one object and the plurality of interactions and activities.

4. The method of claim 3, wherein the conclusion is selected from a set of reasons.

5. The method of claim 4, wherein the reasons are determined by psychological and sociological analysis.

6. The method of claim 3, wherein the conclusions are determined based on an algorithm developed by crowdsourcing.

7. The method of claim 1, wherein the content comprises at least one keyword.

8. The method of claim 7, wherein the relationship graph further links the at least one keyword.

9. The method of claim 1, wherein a moderator provides additional content.

10. The method of claim 9, wherein the additional content is feedback regarding the at least one student.

11. The method of claim 1, wherein the relationship graph is adjusted when additional content is obtained.

12. A recommendation engine for recommending at least one student to an employer over a computer network, comprising:
(a) a content unit operable to obtain content from the at least one student and the employer and extract at least one object from the content; and
(b) a monitor/analyzer unit operable to generate a relationship graph linking the at least one objects and at least one student and the employer and recommend at least one student to the employer based on the relationship graph.

13. The system of claim 12, wherein the monitor/analyzer unit is further operable to associate a plurality of interactions and activities with the at least one object.

14. The system of claim 13, wherein the monitor/analyzer unit is further operable to generate a conclusion regarding the at least one student corresponding to the at least one object and the plurality of interactions and activities.

15. The system of claim 14, wherein the conclusion is selected from a set of reasons.

16. The system of claim 15, wherein the reasons are determined by psychological and sociological analysis.

17. The system of claim 14, wherein the conclusions are determined based on an algorithm developed by crowdsourcing.

18. The system of claim 12, wherein the content comprises at least one keyword.

19. The system of claim 18, wherein the monitor/analyzer unit further links the at least one keyword.

20. The system of claim 12, wherein the content unit is further operable to obtain additional content from a moderator.
